(19) United States
(12) Patent Application Publication
(10) Pub. No.: US 2007/0246451 A1
(43) Pub. Date: Oct. 25, 2007

(54) OVEN CONTROL

(75) Inventor: Paul Eaton Willett, Whiteside (AU)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: MOFFAT PTY LIMITED, Mulgrave (AU)

(21) Appl. No.: 11/738,843

(22) Filed: Apr. 23, 2007

(30) Foreign Application Priority Data
Apr. 24, 2006 (AU) 2006902133

(51) Int. Cl. A21B 1/22

(52) U.S. Cl. 219/394

(57) ABSTRACT

A monitoring and advisory system for a plurality of ovens, including a means for receiving information from the plurality of ovens on the conditions in each oven and the usage of each oven, processor means for determining and identifying which of the plurality of ovens meets a predetermined condition, based on the information received from the plurality of ovens, and forwarding an indication of the identified oven to an output means for interpretation by an operator.

### FIELD OF THE INVENTION

The present invention relates generally to control systems for monitoring and controlling multiple ovens. The invention is particularly suitable for deck ovens comprising multiple oven chambers, and it will be convenient to describe the invention in relation to that exemplary but non-limiting application.

### BACKGROUND OF THE INVENTION

Multiple chamber deck ovens are well known and widely utilised by users. Such ovens may comprise a single heating means connected to several oven chambers, stacked vertically on top of each other or several oven chambers vertically stacked with each having separate heating means. Each oven chamber in the deck oven is provided with an individual control system displaying information about that particular chamber (e.g. temperature, bake time remaining, etc) and allowing a user to control the chamber (e.g. adjust the temperature, set a timer, control the input of steam into the chamber etc.).

Being able to separately control each oven chamber is essential, as it allows each oven chamber to be treated as an individual oven. This independent control, for example, allows a user to have one oven chamber set at a high temperature for baking one product while an adjacent chamber is set at a different temperature (of even turned off) for baking a separate product.

Generally speaking, baking a new product involves preparing the dough (which, depending on the product being made may need to be baked shortly after being prepared or may need to sit and prove for a period of time between preparation and baking), placing the bake into an oven chamber, monitoring the bake to prevent accidental burning, and removing a completed bake from the appropriate chamber.

Management of these activities in respect of deck ovens, especially large deck ovens (some deck ovens include up to 12 independently operable chambers), where each chamber of the oven is potentially at a different temperature and/or different stage in a current bake, becomes quite complicated and is often done inefficiently.

Despite each oven having a bake time all reading different elapsed times, during typical operation, a baker habitually opens the oven doors to constantly visually check the progress of the bake. The complications are further exacerbated by the fact that the vertical arrangement of the deck oven itself generally prevents more than one person interacting with the oven at a time.

### SUMMARY OF THE INVENTION

A monitoring and advisory system for a plurality of ovens, including:

a means for receiving information from the plurality of ovens on the current conditions in each oven and the usage of each oven;

processor means for determining and identifying which of the plurality of ovens meets a predetermined condition, based on the information received from the plurality of ovens on the current conditions of the ovens, and forwarding an indication of the identified oven to an output means for interpretation by an operator.

The determination and identification may be provided in response to an operator inputting certain information through a user interface and the processor means determining the required conditions of the oven from the information. The processor then identifies the next available oven which most closely resembles the required conditions or is capable of resembling the required conditions within a predetermined or acceptable time period,

The information identifying the oven is then conveyed to the operator preferably by a display means. The display means may also display other information on the conditions or usage of the oven. Alternatively some other form of indicia such as an auditory transmission or other visual indication such as a flashing light may be used to indicate the selected oven.

According to a second aspect of the invention, there is provided a method of operating a plurality of ovens comprising the steps of:
determining the operating conditions of a plurality of ovens; and
determining the operating conditions required for a next available oven;
based on the condition of each of the plurality of ovens, determining and identifying which of the plurality of ovens will meet the required operating condition the fastest within a predetermined time period;
outputting to an operator, the identity of the next available oven.

The condition of the ovens is determined from operating variables of each of the plurality of ovens.

In the preferred form of the invention, information is received on the operating variables of an oven. These variables may include the current temperature of the oven, the time until a bake is finished, the time since baking commenced, whether steam is being applied, the humidity in the oven and whether the heating elements are activated.

All of this information or a selection of this information may be displayed on a display means such as a monitor. In response to an enquiry from the operator, the processor means determines and identifies the oven which is best suited for use. The nature of the enquiry may be the operator providing information on the type of product to be baked such as buns, loaves, cakes, rolls etc. The processor has a look-up table of correlating oven temperatures with the type of product and uses this look-up table to identify an oven which is best suited for receiving the dough to be baked,

The decision is made based on a review of the ovens which are currently not in use and the temperature of each oven. The oven which is at a temperature corresponding to the information derived from the look-up table is identified and that oven selection is conveyed to the operator.

If an available oven is not at the required temperature, then the processor reviews the status of the currently used ovens to obtain the time when one will become available generally from the oven timer and the current temperature of the oven. If the oven is at the required temperature and will be available within a predetermined time period, which may be set by the operator, then the selection of that oven is conveyed to the operator preferably by the display means.

Alternatively or concurrently, the processor may determine the time taken for an oven not at the required temperature to heat up to or cool down to the required temperature. If the time to reach the required temperature is less than the time when an oven at the required temperature becomes available or less than a predetermined time, then that oven is identified and the selection conveyed to the operator with an indicator as to when it is at the required temperature. Preferably there is a warning indicia to warn the operator that the oven is not yet at the required temperature but is the next available oven suitable for the product.

In a further aspect of the invention, a computer program for operating a plurality of ovens is also disclosed.

### BRIEF DESCRIPTION OF THE DRAWINGS

The invention will now be described with reference to the accompanying drawings which show a preferred embodiment of the control system. It is to be understood, however, that the invention is not limited to the features of the preferred embodiment shown in the drawings,

FIG. 1 provides a sectional side view of a multiple chamber deck oven;

FIG. 2 provides a high level logical representation of the deck oven depicted in FIG. 1;

FIG. 3 provides a high level logical representation of a deck oven in accordance with an embodiment of the present invention;

FIG. 4 provides a logical representation of the components of a control system in accordance with an embodiment of the present invention;

FIG. 5 provides an exemplary user interface to the control system of FIG. 4; and

FIG. 6 provides a decision making flow chart by which the control system may select the best chamber for a new bake.

### DETAILED DESCRIPTION OF THE EMBODIMENTS

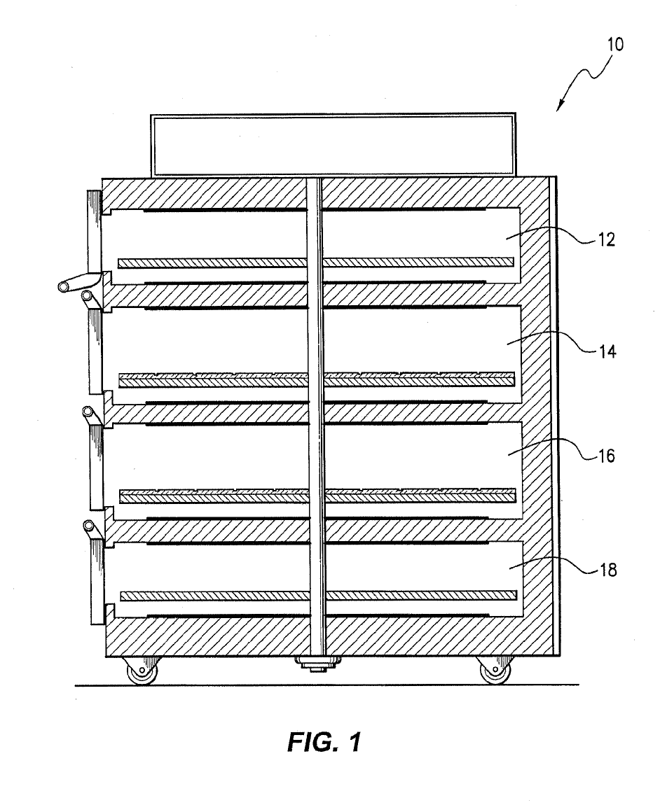

FIG. 1 depicts an example of a multiple chamber deck oven 10. This particular deck oven 10 comprises four independent oven chambers 12, 14, 16 and 18, each chamber with its own control system 20, 22, 24 and 26 respectively. The control systems 20, 22, 24 and 26 allow control of the oven 10 (e.g. setting a temperature, setting a timer, controlling steam generation, controlling flue adjustments) and provides details associated with the chamber (e.g. current temperature of the chamber, time elapsed, time remaining) to the user. The oven 10 is also provided with a heating means (not shown in FIG. 1) which provides heat to each of the chambers by heating each oven with individual heating elements in each oven. Thus essentially the bank of ovens operates as a collection of individual ovens each operated individually.

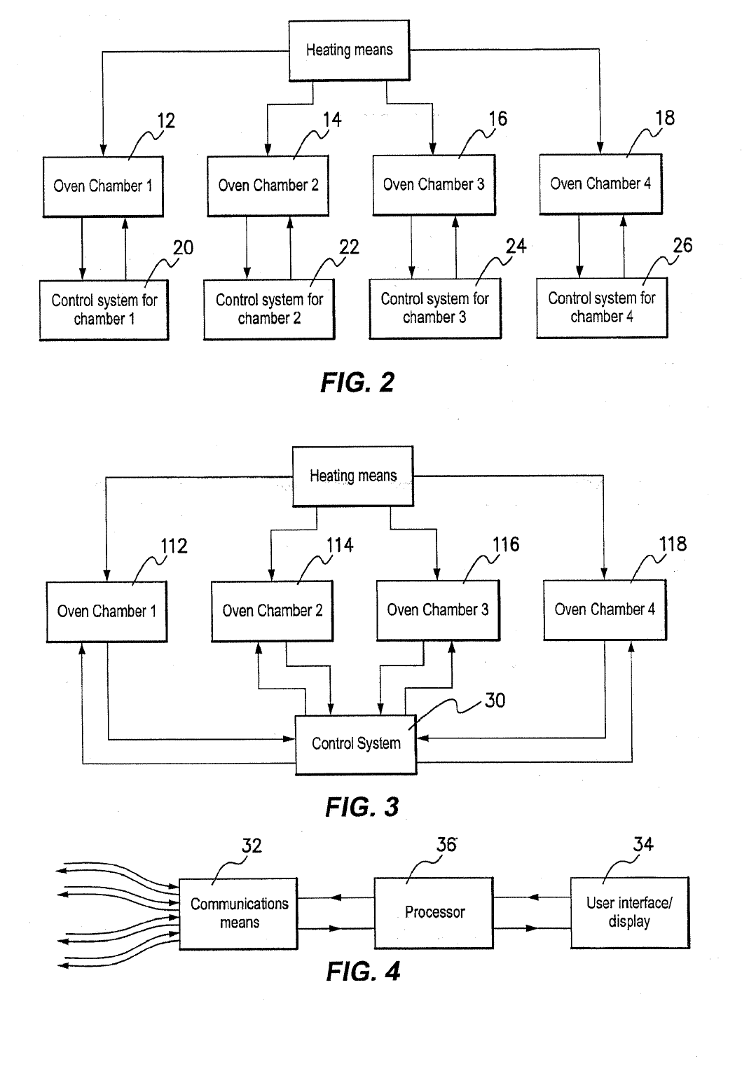

FIG. 2 provides a high level logical representation of the deck oven depicted in FIG. 1. As can be seen, each oven chamber 12 to 18 communicates individually with its associated control system 20 to 26 and is heated by a common heating means 28. Each control system 20 to 26 receives status information from sensors monitoring the environment of the associated oven chamber 12 to 18 (e.g. the temperature of the chamber), and displays this information to the user. When the user interacts with the control system associated with a particular chamber, for example by setting the temperature, the control system sends control signals to the appropriate chamber to effect the control specified by the user.

For the sake of clarity in the present application status information and control signals are depicted as being sent from and to the individual oven chamber to which those signals relate. It will be appreciated, however, that the signals may be sent to different destinations depending on the control required. For example, a control signal to increase the temperature may be sent to one place, a control signal to introduce steam into the chamber a different place, and a control signal to open a flue to a different place again.

FIG. 3 provides a high level logical representation of a deck oven in accordance with one embodiment of the present invention. As can be seen, instead of each oven chamber 112 to 118 being provided with separate control systems, a single control system 30 is provided. The control system 30 is configured to receive status information from, and send control signals to, all oven chambers 112 to 118. The control system 30 may be provided on the deck oven itself or, if desired, may be provided at a remote location so as to leave the face of the deck oven free and allow monitoring and control of the oven chambers from that remote location.

As shown in FIG. 4, the control system 30 broadly incorporates a communication means 32 for receiving status information from, and sending control signals to, each of the chambers controlled by the control means 30, a user interface means 34 for displaying information regarding the ovens to a user and allowing the user to input control signals, and a processor means 36 (discussed in detail below). While the three components of the control system 30 must be able to communicate data between each other, there are numerous ways in which they may be connected to do so. For example, the communication means 32 and processor 36 may be hard wired to each other and to the oven chambers being controlled, but the user interface 34 may connect to the processor via a wireless connection allowing the monitoring of the status of the ovens and the control of the ovens to be achieved from a remote location (for example, the ovens may be in a baking room but may be controlled and monitored by a user from a shop counter).

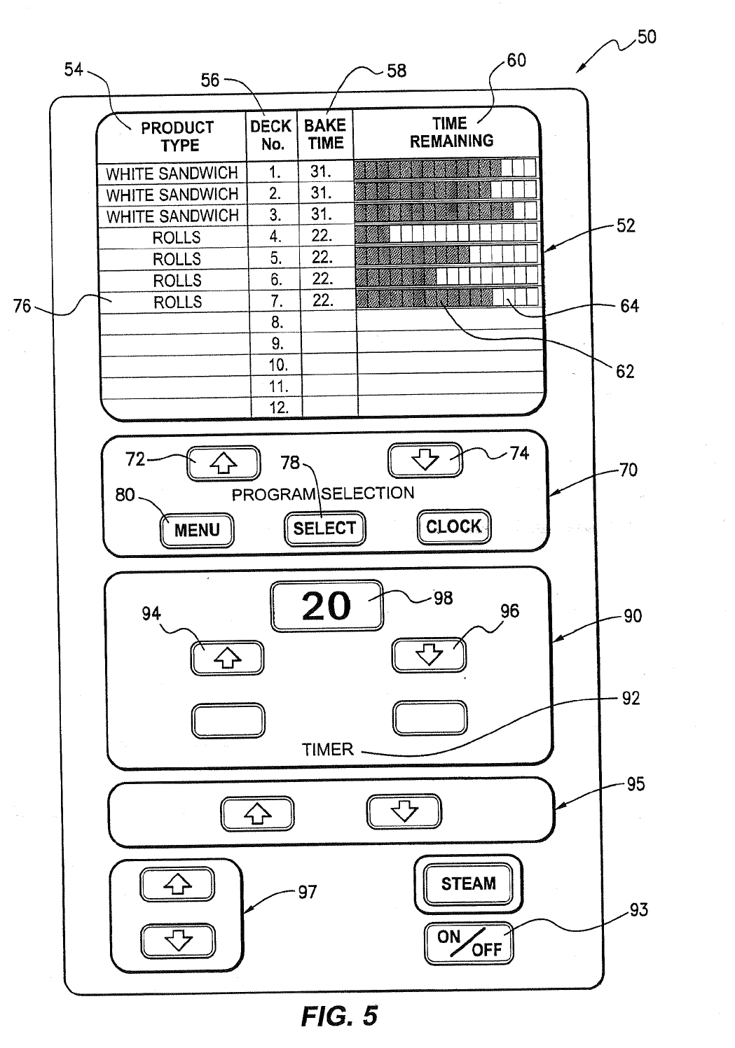

FIG. 5 depicts one example of a user interface 50 that may be provided in order to monitor and/or control the chambers being controlled by the control system 30. The user interface includes a status display 52 which provides a user with crucial information regarding all of the chambers being controlled at a glance. Each chamber being controlled (in this case 12 of them) is displayed in a list, providing information regarding the product 54 (if anything) currently being baked in a particular oven chamber 56, the minutes of bake time elapsed 58, and a visual representation of the bake time remaining 60. As can be seen, the visual representation of the bake time remaining 60 in respect of each chamber is provided in such a way that a user can see immediately which bakes are close to completion, and therefore which ovens need to be checked and how long it will be until a chamber will be free. To further enhance usability and provide a user with the most crucial information immediately, the visual representation of time remaining is split into a first region 62 and second region 64. The first region 62, displaying to the user, for example, that there is only 5 minutes left for a bake and therefore it must be checked/removed shortly, may be shown in a separate colour (e.g. red) to the second region 64.

Other information may be included in this status display 52 as is deemed necessary or relevant. For example, the display could be adapted to also display information as to the current temperature of each of the chambers.

The user interface 52 also includes various control options for controlling the chambers. The selection panel 70 allows a user scroll through the oven chambers attached to the control system 30 and displayed in the status display 52 in order to select a particular oven chamber to be controlled. The user may scroll up or down through the list of chambers displayed in the status display 52 by activating the up button 72 or down button 74 respectively. To show the user which chamber is currently selected the status display 52 may highlight 76 the selected oven. Once the user has highlighted the chamber they wish to control, they may activate the select button 78 to select that chamber.

Once a chamber has been selected in the selection panel 70, the user may press the menu button 80 to transition between various control options, which are then displayed in the control panel 90. The control option currently active will be displayed in an area 92 at the bottom of the control panel 90. In the present example the option selected is the ‘timer’ option, allowing a user to control the timer of the oven chamber selected. Other control options include temperature and bake time. By pressing the up button 94 or down button 96 the selected control option (in this case the timer) may be incremented or decremented respectively. The current value for the control option is displayed in box 98—in FIG. 5, box 98 is showing the user that the time remaining on the selected oven is 20 minutes.

The user interface 50 may also include steam controls, including an on/off button 93 to control the presence or absence of steam in the chambers. One set of controls 95 may be used to manually control the release of steam into the chamber, while the other set of controls 97 may be used to manually control the venting of the steam.

If desired, multiple status displays 52 (with or without the other control features of the user interface 50) may be provided. For example, the status display may display on the oven itself as well as on a screen visible from a shop counter or similar so the status of the chambers may be monitored without having to be in the immediate vicinity of the oven.

The processor 36 is configured to receive status information sent from each of the oven chambers (via the communication means 32), display the status information on the user interface 50, and receive control information entered into the user interface 50 by a user and sending appropriate control messages to the correct destination. In addition, the processor 36 is also configured to implement logical rules to assist the user in making baking decisions.

For example, when a new bake is to be undertaken, instead of a user either analysing the user interface 50 to determine which oven is available or, as traditionally has been the case, go to the oven itself to visually inspect the oven chambers, the user may simply enter in the new product which they wish to bake into a user interface. The processor 36 preferably has a look-up table correlating bake time and temperature with the type of product to be baked. From this information, the processor 36 can determine the most appropriate oven for the bake and set the temperature and bake time accordingly.

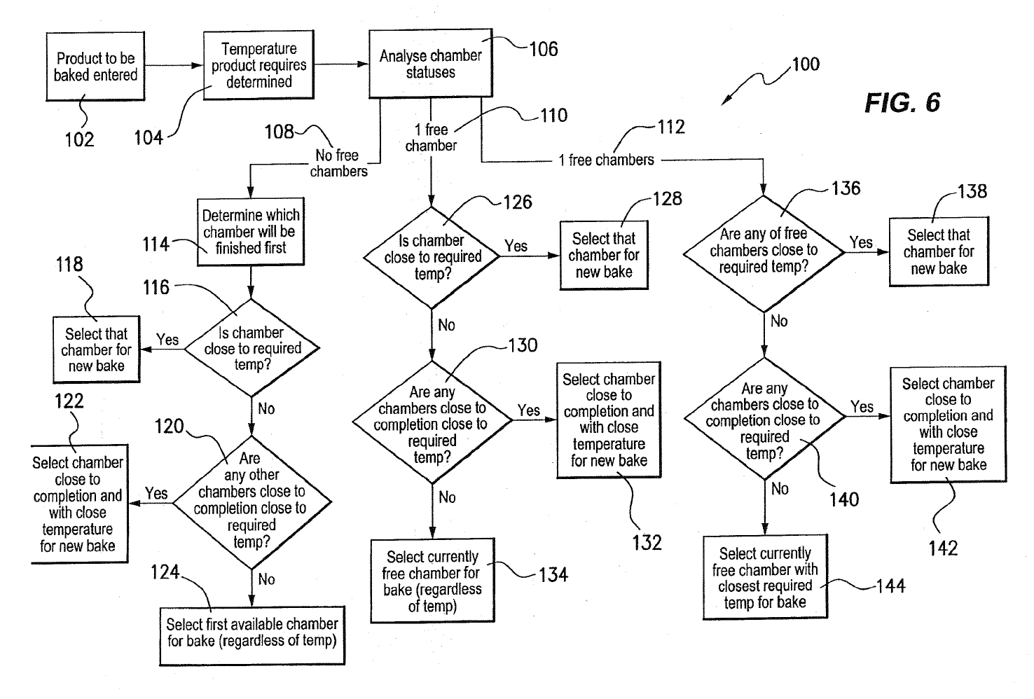

FIG. 6 depicts a flow chart of a simplified decision making process 100 that may be employed by the processor 36 in order to select the most appropriate chamber for a new bake. The new product to be baked is entered into the control system 102 which determines the temperature and time required to bake that product 104. The processor 36 then analyses the status of the chambers 106 and determines whether there are no chambers currently free 108 (i.e. all chambers are currently being used), one chamber free 110, or more than one free chamber 112.

If there are currently no oven chambers available, the processor 36 determines which chamber will be the next to become free 114—i.e. which chamber has the least remaining bake time. If the temperature of the next chamber to become free is close to the temperature required for the new bake 116, that chamber is selected for the new bake 118. If the next chamber to become free is not close to the required temperature for the new bake, the processor 36 determines whether any other chambers will be free at a similar time, and whether any of those chambers are close to the temperature required for the new bake 120 (e.g. the processor determines the next chamber to finish and then looks for chambers that will finish within a predetermined time period, e.g. 5 minutes, from that chamber). If there is a chamber nearing completion that is closer to the required temperature, the processor 36 will select that chamber for the new bake 122. If no other chambers are nearing completion, or there are other chambers nearing completion but they are not close to the required temperature, the processor 36 will select the first chamber due to become available for the new bake 124 (i.e. the initially identified chamber selected in step 118).

For example, it may be the case that the temperature required for the new bake is 200 degrees, the first chamber that will become free is currently at a temperature of 150 degrees, and there is a second chamber that will become free 1 minute after the first chamber which is currently at a temperature of 200 degrees. In this case the processor will determine that the second chamber is to be used for the bake although it is not the first to become free, it will be a better temperature and is therefore the more efficient choice.

If there is one free chamber 110, the processor undertakes a similar decision making process to determine the most appropriate chamber for the new bake. If the free chamber is close to the required temperature it will be selected for the new bake 128. If the chamber isn't close to the required temperature, the processor 36 will analyse the other chambers 130 to determine whether any are close to completion and close to the required temperature. If such a chamber exists the processor 36 selects that chamber for the bake 132 and if not the currently free chamber is selected 134.

If there is more than one chamber free 112, the processor 36 will analyse the temperatures of those free chambers (which may be completely cold or may have just recently been switched off and still be cooling down), to determine whether any are close to the temperature required for the new bake 136. If one of the free chambers is close to the required temperature it is selected for the bake 138. If none of the free chambers are close to the required temperature the processor 36 looks at whether any of the chambers currently in use are close to completion and if so whether any are at a temperature close to the temperature required for the new bake 140. If such a chamber exists the processor 36 selects that chamber for the bake 142 and if not the currently free chamber is selected 144.

Once the processor 36 has selected the chamber to be used for the new bake, it informs the user and, if required, sends control signals to prepare the chamber (e.g. raising the temperature).

While the invention has been described in relation to deck type ovens and a single control system for controlling multiple oven chambers, it will be appreciated that each oven chamber is essentially an oven in its own right, and the control system may easily be adapted to monitor and control any arrangement of such ovens which may be independently controlled.

Since modifications within the spirit and scope of the invention may be readily affected by persons skilled in the art, it is to be understood that the invention is not limited to the particular embodiment described, by way of example, hereinabove.

1. A monitoring and advisory system for a plurality of ovens, including:
a means for receiving information from the plurality of ovens on the current conditions in each oven and the usage of each oven;
processor means for determining and identifying which of the plurality of ovens meets a predetermined condition, based on the information received from the plurality of ovens on the current conditions of the ovens, and forwarding an indication of the identified oven to an output means for interpretation by an operator.

2. The system according to claim 1, wherein the determination and identification is provided in response to an operator inputting certain information through a user interface and the processor means determining the required conditions of an oven from the information.

3. The system according to claim 2, wherein the processor identifies the next available oven which has current conditions resembling the required conditions or is capable of resembling the required conditions within a predetermined or acceptable time period.

4. The system according to claim 2 wherein the user interface is a display means.

5. The system according to claim 4, wherein the display means also displays other information on the current conditions or usage of the oven.

6. The system according to claim 2 wherein the user interface is an auditory transmission.

7. The system according to claim 1 wherein the information received from the ovens on the current conditions of the oven includes at least one variable selected from the group of the current temperature of the oven, the time until a bake is finished, the time since baking commenced, whether steam is being applied, the humidity of the oven and whether the heating elements are activated.

8. The system according to claim 1 wherein the current condition of the oven and required condition of the oven is the current temperature and required temperature respectively.

9. The system according to claim 7 or 8, wherein the determination and identification includes a review of the information of the current condition of the ovens which are currently not in use.

10. The system according to claim 2, wherein the operator provides information on the type of product to be baked.

11. The system according to claim 10, wherein the processor has a look-up table of information of the required oven conditions corresponding to the type of product to be baked and identifies the oven conditions required of the next available oven.

12. the system according to claim 11, wherein the oven which has current conditions corresponding to the information derived from the look-up table is identified and that oven selection is conveyed to the operator.

13. The system according to claim 10, wherein if an available oven is not at the required conditions, then the processor reviews the status of the currently used ovens to obtain the time when one of the currently used ovens will become available from the oven timer and the current conditions of the oven.

14. The system of claim 9 wherein the information on the current oven conditions and the required oven conditions is the current oven temperature and the required oven temperature respectively.

15. The system according to claim 14, wherein, if the oven is at the required temperature and will be available within a predetermined time period, then the selection of that oven is conveyed to the operator.

16. The system according to claim 14 wherein, the processor determines the time taken for an oven not at the required temperature to heat up to or cool down to the required temperature, and if the time to reach the required temperature is less than the time when an oven at the required temperature becomes available or less than a predetermined time, then that oven is identified and the selection conveyed to the operator.

17. The system according to claim 16, further comprising an indicator as to when the oven identified is at the required temperature

18. A method of operating a plurality of ovens comprising the steps of:
determining the current operating conditions of a plurality of ovens;
determining the operating conditions required for a next available oven;
based on the current condition of each of the plurality of ovens, determining and identifying which of the plurality of ovens will meet the required operating condition the fastest or within a predetermined time period, and outputting to an operator, the identity of the next available oven.

19. The method of claim 18 wherein the required operating conditions for the next available oven is determined in response to an operator inputting information related to the required operating conditions.

20. The method of claim 19 wherein the information input by the operator is the required operating conditions.

21. The method of claim 19 wherein the information input by the operator is the type of product to be baked, the required operating conditions being derived from a look-up table relating to the type of product.

22. The method of any one of claims 18 wherein the information on the current condition of the oven is at least one variable selected from the group of the current temperature of the oven, the time until a bake is finished, the time since baking commenced, whether steam is being supplied, the humidity of the oven and whether the heating elements are activated.

23. The method of any one of claims 18 wherein the step of determining and identifying which of the plurality of ovens will meet the required operating condition the fastest or within a predetermined time period includes the step of:
reviewing the current oven conditions of the ovens not in use; and
comparing the current oven conditions of the ovens not in use with the required oven conditions and selecting the oven which will reach the required oven conditions the quickest or within a predetermined time period.

24. The method of claim 23 wherein if an oven not in use is not at the required oven condition the method further includes the step of:
determining when one of the ovens currently in use will become available determining the time for the currently in use oven to reach the required oven condition after the current use is completed; and
comparing the time for the currently in use oven to reach the required oven condition with the time for the oven not in use to reach the required oven conditions and selecting the oven with the lowest time, and identifying the selected oven.

25. The method of any one of claims 18 wherein the information on the current oven conditions and the required oven conditions is the current oven temperature and required oven temperature.
